(19) United States
(12) Patent Application Publication
(10) Pub. No.: US 2013/0344209 A1
(43) Pub. Date: Dec. 26, 2013

(54) System and Method of Separating Eggshells from a Liquid

(71) Applicant: Clifford W. Heinrich, Phoenix, AZ (US)

(72) Inventor: Clifford W. Heinrich, Phoenix, AZ (US)

(21) Appl. No.: 13/527,856

(22) Filed: Jun. 20, 2012

(51) Int. Cl. A47J 43/14

(52) U.S. Cl. 426/298; 99/495

(57) ABSTRACT

An eggshell extraction utensil for selecting, isolating and removing eggshell fragments from a viscous fluid such as egg whites in a container. The utensil includes a handle, strainer portion and lip. The shape of the strainer portion is designed to maximize contact with a container edge and provide ease of use for the intended purpose. A lip extends from the strainer portion to more easily capture eggshell portions. By using the utensil, one may easily extract eggshell fragments during the preparation of certain recipes that require egg.

### BACKGROUND OF THE INVENTION

1. Field of the Invention

This invention relates generally to culinary instruments, and more particularly to a utensil for manually separating chicken eggshell fragments from a viscous liquid of predominantly egg albumen, yolk and/or eggshell membrane.

2. Description of Related Art

Eggs are a mainstay of many diets. Eggs are prepared by cooking, baking and other food preparation methods, often including heating. Eggs are primarily nutritional based on a high protein content, and useful due to the unique nature that egg proteins exhibit as they naturally solidify when cooked. The egg white, or albumen, eggshell membrane and yolk are the primary portions of the eggs that contain nutritional benefits of the proteins and the cooking/baking benefits of transformation. Although high in calcium, the eggshell is predominantly discarded or set aside for other purposes. The egg contents are extracted by puncturing, cracking, or otherwise obliterating the eggshell. In so doing, the hard, brittle shell is often fragmented, leaving small particles in the extracted egg product liquids. In order to provide for a seamless cooking and eating experience, it is necessary to remove these eggshell fragments. The best time to do so, when the eggshells are easily identified, is immediately after extracting the egg contents.

The amateur, as well as the professional, cook or chef often faces this problem. There are various methods for removing the shell fragments, which may include manual finger-removal via poking and pincering the material. Some may use a standard kitchen tool, such as a fork which is not primarily intended for this purpose, and thus not properly adapted for ease and effective use. In all kitchens there are various utensils, all designed to perform different tasks, but as noted, none are designed and allow for the removal of eggshell fragments with exceptional ease.

Prior strainer-spoon utensils have utilized a strainer bottom. In combination with such strainer bottoms, these prior art strainers may use an upturned lip acting as a flange. However, a deficiency of prior art flanges arises from the origin of the shape of such flanges, which are generally adapted to fit the shape of a standard spoon bowl. This lip will not work to easily scrape the edges of various shaped containers. Some tools have been designed to include a scraping edge on a conventional spoon, and have even utilized an articulated flange body hingedly mounted to a spoon edge to overcome this deficiency. Such articulated flanges do not hold up well and are difficult to use by the average, unskilled chef.

Other skimming utensils teach a straight edge with a skimming portion. Certain egg-spatulas may be used to lift, cut, and separate cooked eggs, yet are not designed to extract eggshell fragments from a viscous liquid.

Other multi-use kitchen utensils of a similar nature utilize a spoon-like depression with a plurality of apertures, handle, and a lip/flange for cutting. This utensil is designed to have multiple uses around the kitchen, lessening the number of utensils required, but it is not designed to separate eggshells from a viscous liquid.

However, there has yet to be a tool specifically designed to easily and simply allow for the kitchen user to extract egg-shells from the remainder of the egg, or other viscous liquids and/or adhering substances.

It is therefore an object of the present invention to provide an egg-shell extraction tool that is easy to use.

It is another aspect of the present invention to provide an egg-shell extraction tool that is effective in removing eggshell fragments from a viscous liquid.

It is yet another aspect of the present invention to provide an egg-shell extraction tool that can easily work with a variety of different container shapes.

It is another aspect of the present invention to provide a method for egg-shell extraction that simply uses a single tool for manual removal.

These and other objects of the present invention will be understood through the detailed description of the invention below.

### BRIEF SUMMARY OF THE INVENTION

The present invention provides among other things a tool to extract eggshells from a liquid. It is an objective of this invention to provide a new utensil, and related method that will allow a user to more easily capture eggshell fragments from a liquid. Eggshells are thought to include shells from eggs of any variety of bird, not exclusive of chickens, and will also include any disposable or unwanted container that holds a liquid, or liquid-like substance originating from a container that a user may want to extract from the liquid or liquid-like substance.

The above and other objectives may be achieved using systems involving an egg-shell extraction tool that comprises a handle for manipulation of the tool by a user that further comprises a back end and a front end. The tool may further comprise a joint at the front end of the handle where the joint or hinge connects the handle to a depressed straining surface. This articulated handle may allow for easier access to a container. The depressed straining surface may be comprised of a mesh array of perpendicularly arranged members and may include a lip adjacent to the depressed straining surface. An embodiment of the invention may include a lip extending from the mesh whereby the lip-mesh interface is indistinguishable.

An embodiment of the invention may further comprise a rim surrounding the depressed straining surface, wherein at least one section of the rim is a substantially straight edge forming a defined angle along the rim.

The above and other embodiments may be achieved by using a method of extracting an eggshell from a viscous substance in a container. First, a user will take the extraction tool into one hand, and then insert the straining surface into the eggy substance. By manipulating the straining surface with a handle to capture a portion of eggshell from amidst the substance, the user can mate the straining surface with an edge of the container, and thereby withdraw the straining surface from the substance while capturing at least one eggshell portion. Upon removal from the eggy substance, the substance can be strained through at least one aperture of the straining surface, thereby isolating at least one eggshell portion.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a perspective view of an embodiment of the present invention.

FIG. 2 depicts a top view of an embodiment of the straining surface.

FIG. 3 depicts a top view of another embodiment of the straining surface.

FIG. 4 depicts a top view of yet another embodiment of the straining surface.

FIG. 5 depicts a perspective view of an embodiment of the handle.

FIG. 6 depicts a perspective view of an alternative embodiment of the handle.

FIG. 7 depicts a perspective view of an alternative embodiment of the handle.

FIG. 8 depicts a side view of an embodiment of a portion of the handle, the joint area and the straining surface.

FIG. 9 depicts a perspective view of an embodiment of the joint between the handle and the straining surface.

FIG. 10 depicts a perspective view of another embodiment of the joint between the handle and the straining surface.

FIG. 11 depicts a perspective view of another embodiment of the joint between the handle and the straining surface.

FIG. 12 depicts a perspective cross-sectional view of an embodiment of the straining surface.

FIG. 13 depicts a perspective cross-sectional view of another embodiment of the straining surface.

FIG. 14 depicts a top view of another embodiment of the straining surface.

FIG. 15 depicts a side view of an embodiment of the straining surface and scraping edge.

FIG. 16 depicts a side view of another embodiment of the straining surface and scraping edge.

FIG. 17 depicts a top view of an embodiment of the straining surface and an outer rim corner.

FIG. 18 depicts a top view of another embodiment of the straining surface and an outer rim corner.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details or in further embodiments. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. The full scope of the inventions is not limited to the examples that are described below.

The eggshell extraction tool invention may be comprised of a variety of materials. It may be comprised solely, or in combination, of wood, rubber (real or synthetic), plastic, silicone, or various metals. Different materials would provide various benefits. Metals are easy to sterilize, wood may be biodegradable, rubber can be more flexible, and plastic can be less expensive to manufacture. Some materials may provide durability for a longer period of time than other materials that may be used for disposable invention.

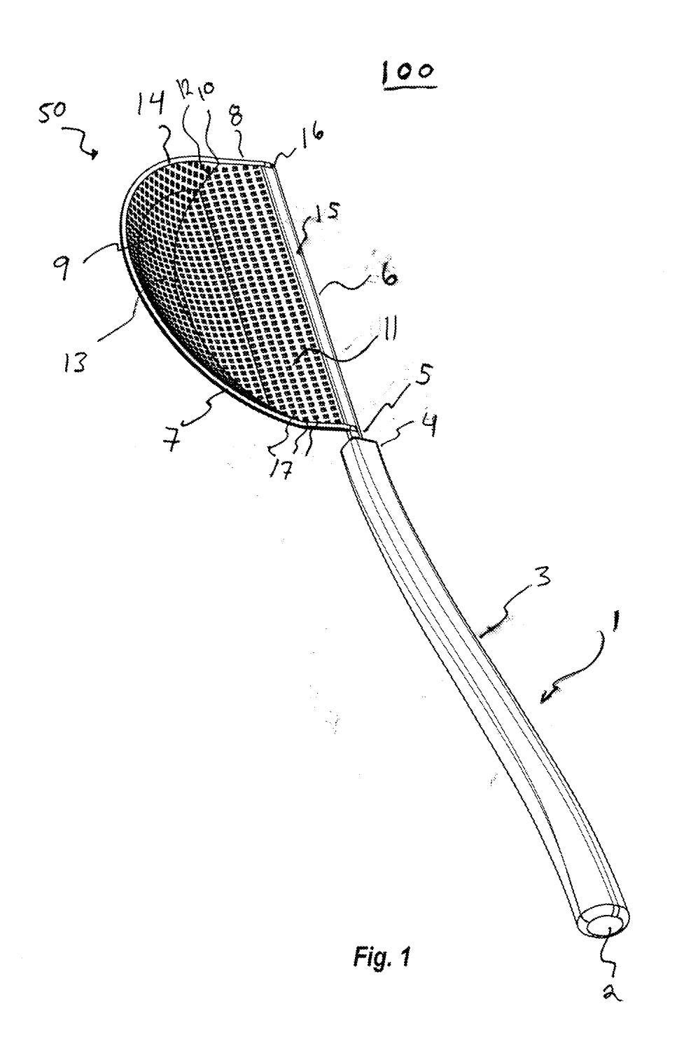

FIG. 1 illustrates an embodiment of the present invention. Handle 1 includes grip portion 3 for manipulating the invention when in a tool embodiment such as an egg-shell remover 100. Grip portion 3 may include ribbing and may be made of the same material as handle 1, or an additional overlay material of the same or alternative type as handle 1. Handle 1 extends from butt 2 to base 4. Base 4 is connected to a joint 5. Joint 5 may be of many types, including articulate, solid, formed of one or more lines of material, etc. Joint 5 connects handle 1 to scouper portion 50. Scouper portion 50 may include frame 18 to house bowl 9 having surface 10 within rim 7. Frame 18 includes side edge 6 for straight edge contact points along any straight container. Rim 7 may also include top edge 8. Top edge 8 may preferably include a straight edge as shown in FIG. 1. Bowl 9 may include a flat surface portion 11, along with depressed portion 13 as may be necessary for the best scouper volume properties. Flat surface 11 and depressed surface 13 meet along bend 12.

Rim 7 may include lip 14 along part, portions or all of rim 7. Sometimes, such lip 14 constitutes frame 7, or may be included in addition to frame 7 made of additional material(s). Side edge 6 may include an angled lip portion 15 to help scrape and maintain contact with a container containing a solution and egg shell fragments. Rim 7 may also include one or more corners, such as corner 16. Corner 16 may include extended lip 15 edge as shown in FIG. 1.

Surface 10 may be made from a single pressed or molded plastic sheet, may be woven of similar materials, or may be comprised of a woven mesh of a fabric such as metal wiring, nylon, etc. Apertures 17 are formed within surface 10. Apertures may be of any shape and distribution. In FIG. 1, they are shown as regularly spaced squares in a grid. When surface 10 is made from molded plastic, any configuration may be pressed into surface 10.

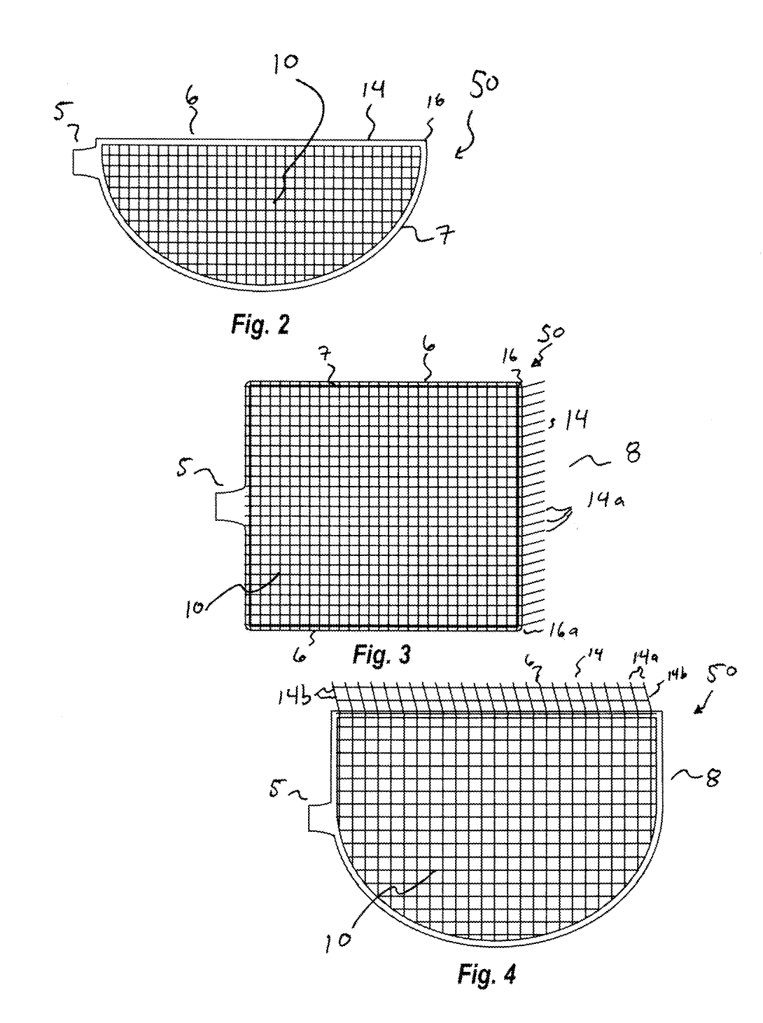

FIG. 2 demonstrates an alternative configuration of scouper 50. Scouper 50 is framed by a solid frame 7 enclosing surface 10. Scouper 50 extends from joint 5 through corner 16 and forms a half-moon shape that is configured to have a sharp corner 16 and significant rounded edge opposite side edge 6. Surface may be depressed or flat, as it may in any of the demonstrated embodiments of the present invention.

FIG. 3 demonstrates an alternative configuration of scouper 50 in a rectangular shape made from wire mesh. Frame 7 is made from overlapping surface portions as shown in FIG. 13. This embodiment includes two straight edges 6 on either side of surface. Top edge 8 extends along the entirety of the width of surface 10 and scouper 50. This embodiment includes two corners 16 and 16a. Scouper extends from joint 5 to top edge 8. Lip 14 of this embodiment is made from extended ends of wire from the mesh that comprises surface 10. Each extending wire 14a provides finger-like reach and grip to further ensnare egg shell particles when in viscous solution.

FIG. 4 demonstrates an alternative configuration of scouper 50 in a bi-modal shape made from wire mesh. Scouper 50 extends from joint 5 to top edge 8. Top edge 8 extends partially along the width of scouper 50. Frame 7 provides support for bi-modal shape of surface 10. Side edge 6 includes extending lip 14. In this embodiment, as shown, the surface 10 is made from wire mesh. Mesh surface extends beyond frame 7 at side edge 6, and includes supporting wires 14b.

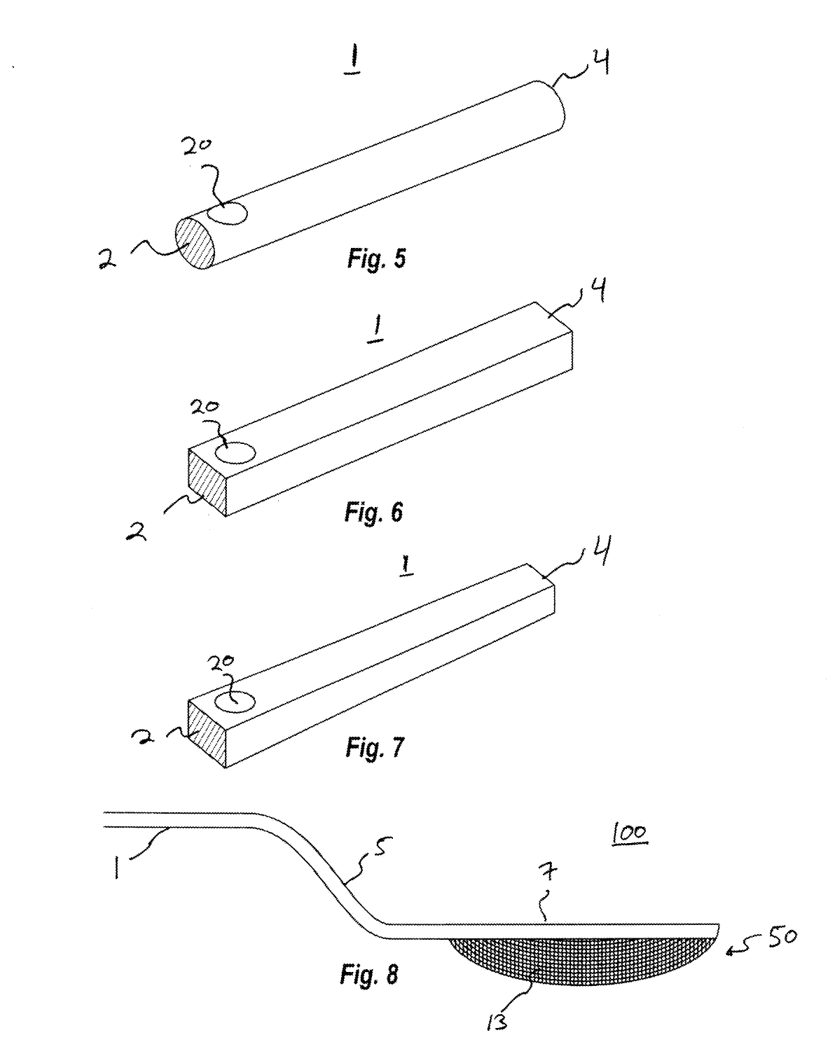

Alternative forms of handles are demonstrated in FIGS. 5-8. Each handle 1 includes butt 2 and base 4, along with hole 20 bored through handle 1 to allow for hanging, storage, other holding methods, or manipulation of tool 100.

In an embodiment shown in FIG. 6, handle 1 is flat and rectangular from butt 2 to base 4. This configuration is easy to manufacture. Alternatively, the handle 1 may be tapered, as shown in FIG. 7, so that the butt 2 is wider than the base 4. This configuration may be more ergonomic. In an embodiment shown in FIG. 5, the handle 1 may be rounded, similar to a dowel, so that the handle 1 is one cylinder from the butt 2 to base 4. As in FIG. 1, this cylinder-like handle may also be tapered so that the back end is thicker than the front end.

FIG. 8 shows an alternative style handle 1 including significant dip along joint 5. Handle 1 may be extended along joint 5, or such a dipping joint may be apart from the handle grip portion 3. In this embodiment frame 7, joint 5 and handle 1 are comprised of a single piece of material. Depressed portion 13 of scouper 50 hangs below frame 7.

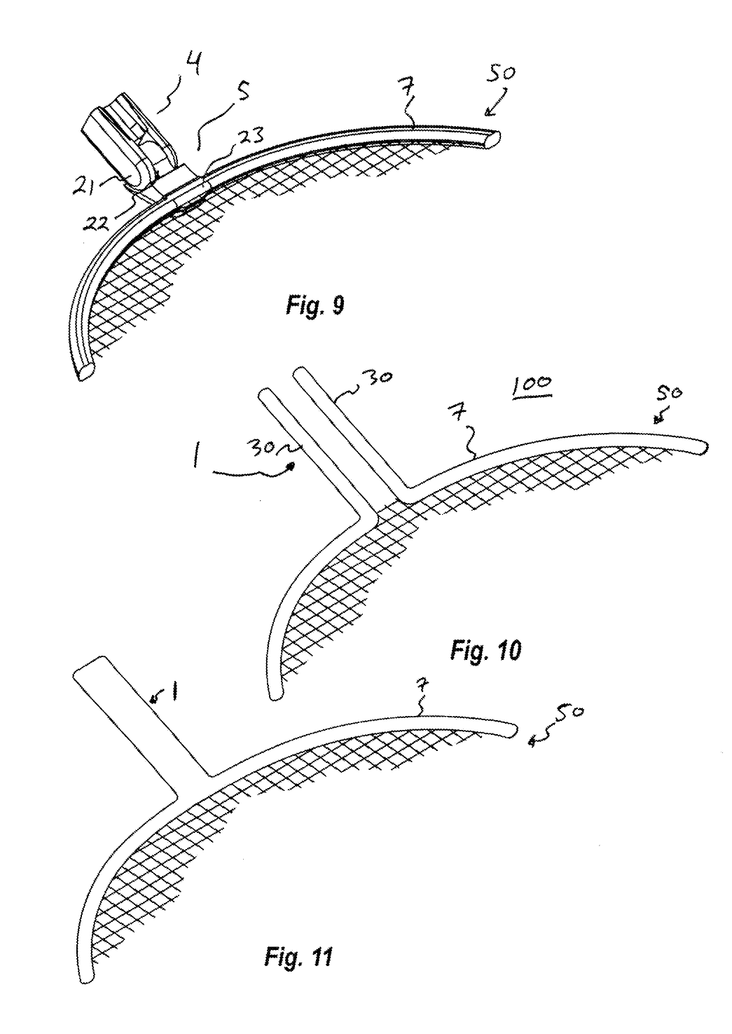

Joint 5 of FIG. 9 demonstrates an articulating embodiment that includes male portion 22 and female portion 21, as an example of a type of articulable joint. Base 4 is attached via joint 5 to scouper 50. Joint 5 interacts with scouper 50 may be reinforced with connection section 23 that serves to support the connection of handle 1 and scouper 50.

In an embodiment shown in FIG. 10, the handle 1 is formed of at least one wire 30 so that handle 1 is wire-framed. In FIG. 10 the embodiment shows handle 1 utilizing two wires 30 that extend along frame 7, around scouper 50, and comprise a singular loop of wire around substantially the entire tool 100. The wire may be of wood, plastic, rubber (real or synthetic), and/or metal. This wire-frame configuration may be easy to manufacture and easy for a user to utilize. Wire 30 may be comprised of an easily bendable metal material that will allow a user to shape tool 100 for reaching into any specific container type.

FIG. 11 shows an alternative style whereby joint 5 is almost vanished and handle 1 and scouper 50 seamlessly meet using a single piece of material along frame 7.

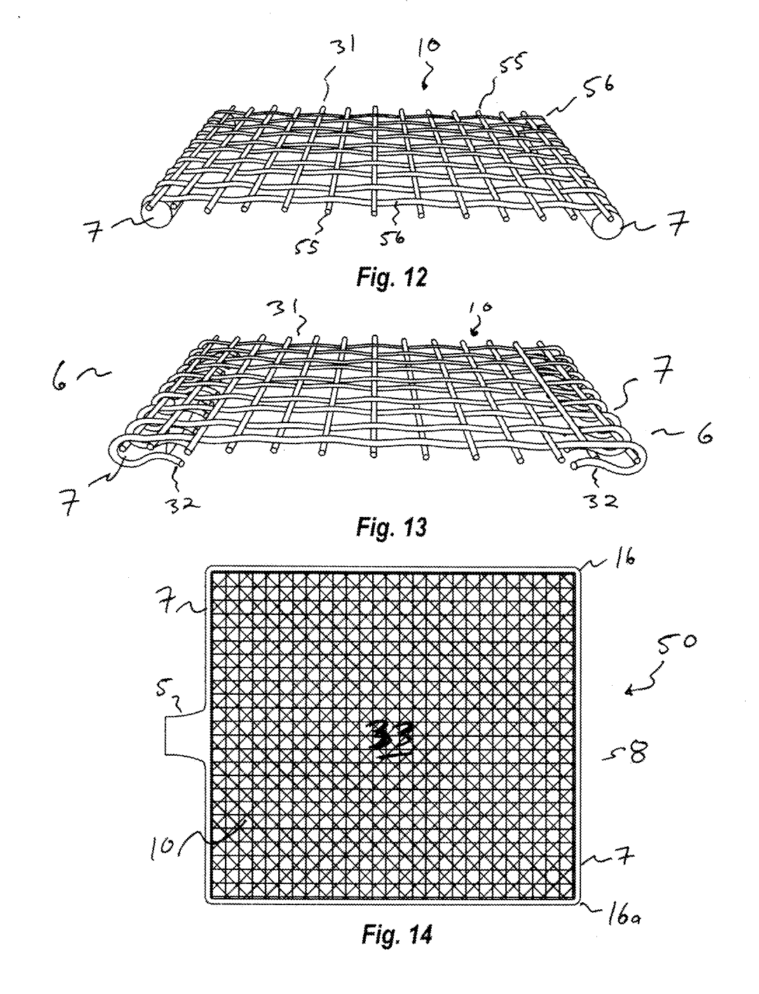

FIGS. 12 and 13 demonstrate alternative mesh-type scouper surfaces 10. In FIG. 12 the mesh 31 may form surface 10 by woven wires. Surface extends to and covers frame 7, whereby frame is made from an extended cylindrical beam. In the alternative shown in FIG. 13, frame 7 is comprised of overlapping portion 32 of wire mesh 31 that also forms surface 10. In this instance folded wire overlapping portion 32 forms edges 6.

FIG. 14 shows scouper 50 from joint 5 to top edge 8 whereby scouper 50 is formed into rectangular shape having corners 16 and 16a. Frame 7 extends around surface 10. Surface 10 includes cross-woven mesh 33. Mesh 33 may be woven, compressed, or layered in any way known in the art.

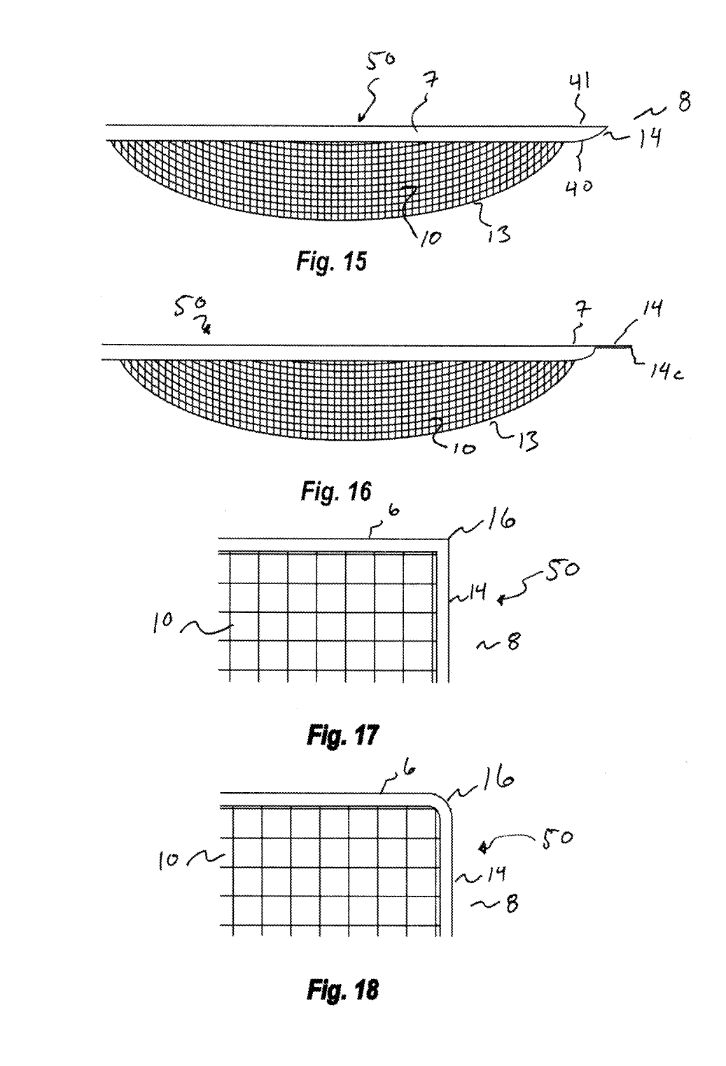

FIGS. 15 and 16 show alternative side views of scouper 50. Surface 10 includes depressed portion 13 extending below frame 7. In FIG. 15, top edge 8 includes lip 14 extending beyond depressed portion 13. Here, lip 14 includes a rounded bottom edge 40 and flat top 41. In FIG. 16, lip 14 is similar to that shown in FIG. 15, but also includes extended lip 14c that may be flat and allow further, more flexible reach of scouper 50. It is contemplated that lip may be comprises of a rubber, silicone, or other flexible product that will adapt to many or any container shape.

FIGS. 17 and 18 demonstrate various corners 16 of scouper 50. Each shows surface 10 bounded by side edge 6 and top edge 8. Lip 14 is also demonstrated along the entire perimeter of surface. Corner may be pointed, right angle (as shown in FIG. 17) or rounded (as shown in FIG. 18).

In an embodiment shown in FIG. 5, handle 1 includes hole 20 completely through it, which is substantially near butt 2 so that an embodiment of the invention 100 may be hung from a hook (not shown). This allows for easy storage and access.

Handle 1 may be any length, with different lengths useful for slightly different purposes and containers.

In an embodiment shown in FIG. 9, handle 1 is comprised of multiple pieces. This configuration may be easy to manufacture. It could also allow the invention to be foldable, so that it is easier to store and use.

In an embodiment shown in FIG. 8, handle 1 has multiple curves. This configuration may be more ergonomic and easier to use than some other configurations. It may also allow the tool 100 to reach into places and containers that would not be possible in some other configurations.

In an embodiment shown in FIG. 8, handle 1 may be placed at a positive or negative angle relative to line extended from the bottom of the depressed portion. Handle 1 may be substantially parallel to this line. These various configurations may help the user utilize the tool efficiently. It may be possible that handle 1 can be adjusted for various angles for various users and uses.

In many embodiments (some may be seen in FIG. 1, FIGS. 9-11), handle 1 is connected to straining surface 10 through some type of joint 5 located substantially near the base 4 of handle 1. Joint 5 may be any type of screw, nail, glue, or any other type of fastener. It may be that there is no separate joint and handle and straining surface 10 frame 7 are manufactured partially out of one connected piece of material. Joint 5 may be made out of the same or different material than handle 1 and/or straining surface 10.

In an embodiment shown in FIG. 9, joint 5 is movable and/or adjustable so that the angle of the straining surface can be adjusted. The angle may be adjusted in all directions (in a limited example, front-to-back, and/or side-to-side). Joint 5 may be removable, whether it be a tongue-and-groove configuration or some other. This joint may be permanent or temporary. It may be easy to take apart so that the invention can be more easily stored and/or more easily cleaned.

Straining surface 10 attached to handle 1 may have many different embodiments. Some of these embodiments are shown in FIGS. 1-4, and FIGS. 9-18, and are detailed below.

In an embodiment shown in FIG. 9, the straining surface attached to handle 1 may be at an angle between −45 and 60 degrees from a plane that is substantially parallel to handle 1.

In an embodiment shown in FIG. 2, scouper 50 is comprised of an outer rim frame 7 and a mesh surface 10 attached to the outer rim frame 7 forming a depressed straining surface (shown in alternative figure, i.e. FIG. 15). This outer rim frame 7 may be comprised of a single component or of multiple components. The outer rim frame 7 may be comprised of the mesh itself, by having a portion of the mesh substantially near the edge of the straining surface folded over itself so that there is a distinct end of the straining surface where the mesh is thicker than in the majority of the surface. The outer rim may be thick or it may be thin. The outer rim may comprise a substantial amount of the straining surface or it may be comprised of the straining mesh itself. The outer rim may be flat, rectangular, triangular, and/or rounded. The outer rim may form rounded, as shown in FIG. 17, or sharp, as shown in FIG. 18, corners. There may be no defined corners so that the utensil has a conventional spoon shape.

In an embodiment shown in FIG. 2, the frame 7 forms a scraping edge, on side edge 6, or on one or more sides of the scouper 50 so that a user may scrape the edges of a container in order to capture as many eggshell fragments as possible. This scraping edge, or lip 14, may extend substantially past the outer rim. The scraping edge(s) may be angled to form a better scraping utensil.

In an embodiment, the shape of the frame 7 is similar to that of a spoon as it is elliptical in shape. In another embodiment as seen in FIG. 3, the straining surface may be substantially rectangular or quadrilateral in shape. In other embodiments as seen in FIG. 4, the straining surface may have a substantially straight edge on at least one particular side and rounded edges on the remaining sides. This substantially straight edge may be located on any side of the straining surface besides the side where handle 1 is located. The substantially straight edge may be located on a side edge 6 substantially parallel to handle 1 or it may be located on the side substantially perpendicular to handle 1. The side substantially perpendicular to handle 1 is the top edge 8 of the straining surface.

In an embodiment shown in FIG. 12, the mesh 31 may be composed of an array of perpendicularly arranged members 55 and 56 that create apertures 17 (i.e. holes) to allow various substances to flow through straining surface 10. These perpendicularly arranged members 55 and 56 may form substantially equilateral holes as apertures 17. The members of the mesh may be arranged in various complex arrangements that are not perpendicular and do not form substantially equilateral holes.

In an embodiment shown in FIG. 1, the mesh of surface 10 is comprised of the same material as handle 1. This material may be wood, metal, rubber (real or synthetic), a plastic, or any combination. The mesh may be attached to the outer rim or frame 7 by glue, it may be folded over the outer rim and connected to itself, it may be welded to the outer rim, or it may be attached in any other way that will allow the mesh to stay connected to the straining surface end of the utensil.

In an embodiment shown in FIG. 12, the mesh 31 consists of a single thickness of arranged members. In another embodiment, as seen in FIG. 13, the mesh 31 is comprised of at least a double thickness of arranged members. This double thickness may be achieved by folding the mesh around the outer rim frame in overlapping manner 32 into a double mesh.

In an embodiment shown in FIG. 3, the mesh may extend beyond the outer rim in order to create a scraping edge that is comprised of the mesh, instead of a solid outer rim. This arrangement may help the user capture more eggshell fragments.

1. An eggshell extraction tool for extracting an eggshell fragment from an interior surface of a container, said extraction tool comprising:
a handle for manipulation of the tool by a user, said handle comprising a back end and a front end;
a straining surface;
; and
a lip adjacent to said straining surface forming an outer rim of said straining surface, said lip arranged for mating with the surface of the container;
whereby at least one section of said rim comprises a right angle formed between two straight edges; and
whereby at least one additional section of said rim is curved.

2. The eggshell extraction tool of claim 1 further comprising an interface between said lip and said straining surface;
said lip comprising a mesh; and
whereby said lip-mesh interface is indistinguishable.

3. (canceled)

4. The eggshell extraction tool of claim 1 further comprising a joint situated at said front end of said handle, wherein said joint is hinged.

5. The eggshell extraction tool of claim 1 wherein said handle is articulated.

6. A method of extracting an eggshell from a viscous substance held in a container, comprising the steps of:
taking an extraction tool into one hand, the extraction tool having a handle, a straining surface comprising at least one aperture, and a straining surface edge;
gripping the extraction tool by the handle;
inserting at least a portion of the straining surface into the substance;
manipulating a relative location of the straining surface in order to capture at least a portion of the eggshell from amidst the substance;
mating the straining surface edge with an interior edge of the container;
withdrawing the straining surface from the substance whilst capturing the at least portion of the eggshell on the straining surface; and
straining the substance through the at least one aperture of the straining surface, isolating the at least portion of the eggshell.

7. The eggshell extraction tool of claim 1 wherein said straining surface comprised of a mesh array of substantially perpendicularly arranged members; and

8. The eggshell extraction tool of claim 7 whereby said straining surface being depressed.

9. An eggshell extraction tool for extracting an eggshell fragment from an interior surface of a container, said extraction tool comprising:
a handle for manipulation of the tool by a user, said handle comprising a back end and a front end;
a straining surface comprised of a mesh array of substantially perpendicularly arranged members; and
a lip adjacent to straining surface forming a structural support of said straining surface;
whereby said mesh array extends beyond said lip to form fingers arranged for mating with the surface of the container.

10. An eggshell extraction tool for extracting an eggshell fragment from an interior surface of a container, said extraction tool comprising:
a handle having a first butt end and a second base end, whereby said base couples a straining surface portion;
said handle having three segments along said handle, a first segment extending from said butt end, a third segment substantially adjacent to said base end, and a second segment between said first and third segment;
whereby said first segment is adapted as a handle, said first segment and said second segment meeting at a downward curving angle;
whereby said second segment provides a dip to offset the first segment from the straining surface portion;
whereby said second segment and said third segment meeting at an upwardly curving angle; and
whereby said first and third segments align substantially parallel to one another.

11. The eggshell extraction tool of claim 10 further comprising a lip adjacent to said straining surface portion forming an outer rim of said straining surface, said lip arranged for mating with the surface of the container.

12. The eggshell extraction tool of claim 11
whereby at least one section of said rim comprises a right angle formed between two straight edges; and
whereby at least one additional section of said rim is curved.
